(19) United States
(12) Patent Application Publication
(10) Pub. No.: US 2024/0305629 A1
(43) Pub. Date: Sep. 12, 2024

(54) SERVER DEVICE, BIOMETRIC AUTHENTICATION METHOD, AND STORAGE MEDIUM

(71) Applicant: NEC CORPORATION, Minato-ku, Tokyo (JP)

(72) Inventors: Naotake Fujita, Tokyo (JP); Yoshiakl Okuyama, Tokyo (JP)

(73) Assignee: NEC CORPORATION, Minato-ku, Tokyo (JP)

(21) Appl. No.: 18/273,709

(22) PCT Filed: Feb. 17, 2021
(86) PCT No.: PCT/JP2021/005836

§ 371 Date: Jul. 21, 2023

(51) Int. Cl. H04L 9/40

(52) U.S. Cl. CPC H04L 63/0861

(57) ABSTRACT

Provided is a server device that improves convenience in an authentication system including a plurality of authentication terminals. The server device comprises an acquisition unit and an authentication unit. The acquisition unit acquires an authentication rule including a condition for determining authentication success. The authentication unit performs a first biometric authentication in response to a first authentication request transmitted from a first terminal, and performs a second biometric authentication, using the authentication rule, in response to a second authentication request transmitted from a second terminal.

### TECHNICAL FIELD

The present invention relates to a server device, a system, a biometric authentication method, and a storage medium.

### BACKGROUND ART

PTL 1 discloses an individual processing method for a person passing through a gate. In addition to the access control of the user using the gate, biometric authentication is used for various services.

PTL 2 describes that a personal authentication system capable of easily setting a cooperation service between a personal authentication unit and a management server and improving responsiveness of the cooperation service is obtained. The system of PTL 2 includes a management server and a cooperation service adjustment unit. The management server can perform device management associated with an authentication result in the authentication device. In response to the cooperation service request from the management server, the cooperation service adjustment unit establishes a right of access between the management server and the authentication device, and sets association between an authentication result in the authentication device and device management by the management server.

PTL 3 describes providing a personal authentication system and a method of the personal authentication in which the personal authentication is reliably performed by complementing the uncertainty of the authentication system by the biometric information and also in consideration of the improvement of the convenience of the user. PTL 3 describes that personal authentication can be performed by a combination of optimum authentication methods according to a user, a transaction type, and the like. The system of PTL 3 includes an authentication rule database, an authentication information database, an authentication information reception unit, and an authentication information determination unit. In the authentication rule database, a combination of authentication methods and an authentication order are registered for each account, each transaction, and the like. In the authentication information database, authentication data related to each authentication method is registered. When the authentication information reception unit receives the authentication data input to the customer terminal, the authentication information determination unit performs personal authentication by collating the authentication information database or the like according to the rule registered in the authentication rule database.

### CITATION LIST

### Patent Literature

PTL 1: JP 6767138 B1
PTL 2: JP 2007-109170 A
PTL 3: JP 2004-240645 A

### SUMMARY OF INVENTION

### Technical Problem

A system using biometric authentication may include a plurality of service terminals (authentication terminals). Such a service terminal operates independently for each of a plurality of times of service use even when use places and use times are close to each other. As a result, there may be a problem in the balance between safety and convenience in using the system. For example, in a hotel having a check-in terminal compatible with biometric authentication, an entrance/exit gate, and an entrance/exit function, it is not desirable that a user who has not checked in can move to a lodging building through the entrance/exit gate in order to ensure the safety of the hotel. Similarly, it is also not desirable to be able to enter and exit from the lodging building without passing through an entrance/exit gate. However, in the conventional biometric authentication that operates independently for each service use, it is difficult to suppress an undesirable operation in which a user who has not checked in moves to the lodging building through the entrance/exit gate. Similarly, it has also been difficult to suppress an undesirable operation of being able to enter and exit from the lodging building without passing through an entrance/exit gate after completing check-in. For a user, when the user can enter the lodging building before check in, but does not obtain the right of use of the room to stay, the user is required to return to the check in counter, which deteriorates convenience that should be obtained by biometric authentication.

The problem can not be solved by applying the techniques of PTL 2 and PTL 3. This is because, in PTL 2, a plurality of times of authentication by a plurality of authentication devices is not assumed. In the same manner as in PTL 3, the document does not assume a plurality of times of authentication by a plurality of authentication devices. Further, in PTL 3, it is assumed that the system is applied to a bank aiming at a one-stop window in which all requirements can be satisfied only by a bank customer authenticating once at one window.

A main object of the present invention is to provide a server device, a system, a biometric authentication method, and a storage medium that contribute to improving convenience in an authentication system including a plurality of authentication terminals.

### Solution to Problem

According to a first aspect of the present invention, there is provided a server device including an acquisition unit that acquire an authentication rule including a condition for determining that authentication is successful, and an authentication unit that performs first biometric authentication in response to a first authentication request transmitted from a first terminal and performs second biometric authentication using the authentication rule in response to a second authentication request transmitted from a second terminal.

According to a second aspect of the present invention, there is provided a system including a first terminal, a second terminal, and a server device connected to the first and second terminals, wherein the server device includes an acquisition unit that acquires an authentication rule including a condition for determining that authentication is successful, and an authentication unit that performs first biometric authentication in response to a first authentication request transmitted from the first terminal and performs second biometric authentication using the authentication rule in response to a second authentication request transmitted from the second terminal.

According to a third aspect of the present invention, there is provided a biometric authentication method including a server device acquiring an authentication rule including a condition for determining that authentication is successful, and performing first biometric authentication in response to a first authentication request transmitted from a first terminal and performing second biometric authentication using the authentication rule in response to a second authentication request transmitted from a second terminal.

According to a fourth aspect of the present invention, there is provided a non-transitory computer-readable storage medium storing a program for causing a computer mounted on a server device to execute a step of acquiring an authentication rule including a condition for determining that authentication is successful, and a step of performing first biometric authentication in response to a first authentication request transmitted from a first terminal and performing second biometric authentication using the authentication rule in response to a second authentication request transmitted from a second terminal.

### Advantageous Effects of Invention

According to each aspect of the present invention, there is provided a server device, a system, a biometric authentication method, and a storage medium that contribute to improving convenience in an authentication system including a plurality of authentication terminals are provided. The effect of the present invention is not limited to the above. According to the present invention, other effects may be exhibited instead of or in addition to the effect.

### BRIEF DESCRIPTION OF DRAWINGS

FIG. 1 is a diagram for describing an outline of an example embodiment.

FIG. 2 is a diagram illustrating an example of a schematic configuration of an authentication system according to the first example embodiment.

FIG. 3 is a diagram for explaining an operation of the authentication system according to the first example embodiment.

FIG. 4 is a diagram for explaining an operation of the authentication system according to the first example embodiment.

FIG. 5 is a diagram for explaining an operation of the authentication system according to the first example embodiment.

FIG. 6 is a diagram for explaining an operation of the authentication system according to the first example embodiment.

FIG. 7 is a diagram for explaining an operation of the authentication system according to the first example embodiment.

FIG. 8 is a diagram illustrating an example of a processing configuration of a server device according to the first example embodiment.

FIG. 9 is a diagram illustrating an example of an authentication information database according to the first example embodiment.

FIG. 10 is a diagram for explaining an operation of an authentication rule acquisition unit according to the first example embodiment.

FIG. 11 is a diagram illustrating an example of an authentication rule management database according to the first example embodiment.

FIG. 12 is a diagram illustrating an example of a log management database according to the first example embodiment.

FIG. 13 is a flowchart illustrating an example of an operation of an authentication unit according to the first example embodiment.

FIG. 14 is a flowchart illustrating an example of an operation of the authentication unit according to the first example embodiment.

FIG. 15 is a diagram illustrating an example of a processing configuration of a main terminal according to the first example embodiment.

FIG. 16 is a diagram illustrating an example of a reservation holder information database according to the first example embodiment.

FIG. 17 is a diagram showing an example of a processing configuration of a subordinate terminal according to the first example embodiment.

FIG. 18 is a sequence diagram illustrating an example of an operation of the authentication system according to the first example embodiment.

FIG. 19 is a diagram for describing an object of the second example embodiment.

FIG. 20 is a diagram illustrating an example of a hardware configuration of the server device of the present disclosure.

FIG. 21 is a diagram for explaining a modification of the present disclosure.

FIG. 22 is a diagram for explaining a modification of the present disclosure.

FIG. 23 is a diagram for explaining a modification of the present disclosure.

FIG. 24 is a diagram illustrating an example of a processing configuration of a main terminal and a subordinate terminal according to a modification of the disclosure of the present disclosure.

FIG. 25 is a diagram illustrating an example of a processing configuration of a main terminal and a subordinate terminal according to a modification of the disclosure of the present disclosure.

FIG. 26 is a diagram illustrating an example of a schematic configuration of an authentication system according to a modification of the disclosure of the present disclosure.

### EXAMPLE EMBODIMENT

First, an outline of an example embodiment will be described. The reference numerals in the drawings attached to this outline are attached to each of elements for convenience as an example for assisting understanding, and the description of this outline is not intended to be any limitation. Unless there is a specific reason to the contrary, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. In the present specification and the drawings, elements that can be similarly described are denoted by the same reference numerals, and redundant description can be omitted.

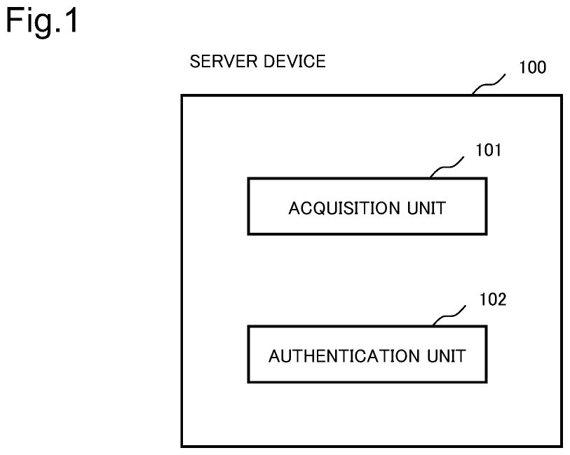

A server device 100 according to an embodiment includes an acquisition unit 101, and an authentication unit 102 (see FIG. 1). The acquisition unit 101 acquires an authentication rule including a condition for determining that authentication is successful. The authentication unit 102 performs a first biometric authentication in response to a first authentication request transmitted from a first terminal and performs a second biometric authentication, using the authentication rule, in response to a second authentication request transmitted from a second terminal.

The authentication system including the server device 100 can include authentication terminals (first terminal, second terminal) installed at a plurality of places, and can provide different services to the user at the plurality of different places. For example, in a real shop such as a retail store, a hotel, or the like, a check in procedure, access control such as gate entry/exit management, a settlement service, or the like is provided to the user. That is, the authentication system including the server device 100 is based on the premise that different biometric authentication devices (authentication terminals) at a plurality of places perform different authentication a plurality of times. The server device 100 acquires an authentication rule for determining that authentication is successful in the second and subsequent authentications among the plurality of times of authentications from the outside (system administrator or the like). More specifically, the administrator himself/herself can set an authentication rule for determining that authentication in an authentication terminal associated with authentication of a settlement terminal, a gate, or the like, installed after an entrance/exit of a hotel, a retail store, or the like, is successful. In an authentication system including a plurality of authentication terminals, an administrator can flexibly set an authentication rule in such a way as to enhance convenience of a user (for example, a product purchaser or a hotel guest). As a result, the convenience of the user is improved. Since the authentication success of the preceding terminal is required for the authentication of the subsequent terminals of the plurality of authentication terminals, the risk in the system is appropriately managed. In other words, the administrator can set the authentication rule in consideration of a (acceptable) risk suitable for the user's action schedule. As described above, the server device 100 according to the example embodiment can achieve both the risk reduction and the convenience at the time of purchasing the article or the service in the real shop a plurality of times in a short period, and both the risk reduction and the convenience at the time of entering and leaving the physical area such as the building or the room a plurality of times in a short period.

Hereinafter, specific example embodiments will be described in more detail with reference to the drawings.

### First Example Embodiment

The first example embodiment will be described in more detail with reference to the drawings.

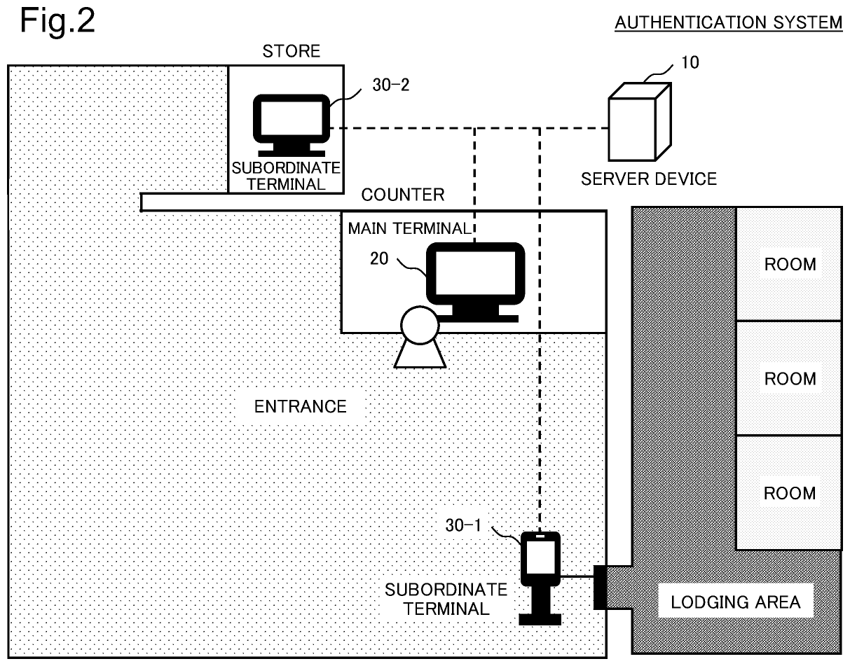

FIG. 2 is a diagram illustrating an example of a schematic configuration of the authentication system according to the first example embodiment. Referring to FIG. 2, the authentication system includes a server device 10, a main terminal 20, and subordinate terminals 30-1 and 30-2.

In the following description, in a case where there is no particular reason to distinguish the subordinate terminals 30-1 and 30-2, it is simply referred to as the “subordinate terminal 30”.

For example, the authentication system of the present disclosure is used for providing a service performed in a hotel as illustrated in FIG. 2. Specifically, the user (guest) performs a check in procedure using biometric authentication on the main terminal 20 installed in the counter at the entrance. Alternatively, when moving from the entrance to the lodging area, the user opens a gate or a door by biometric authentication in the subordinate terminal 30-1. Alternatively, the user makes settlement by biometric authentication on the subordinate terminal 30-2 installed in the store.

The server device 10 is a device that provides a service related to biometric authentication. The server device 10 stores biometric information about the user. The server device 10 receives an authentication request from an authentication terminal (main terminal 20 and subordinate terminal 30). The server device 10 executes biometric authentication using the stored biometric information and identifies an authenticatee. The server device 10 transmits the authentication result (authentication success, authentication failure) to the authentication terminal. The server device 10 may be installed in a hotel or may be installed on a cloud.

The biometric authentication executed by the server device 10 includes two types.

The first biometric authentication is normal biometric authentication using biometric information stored in the server device 10. The server device 10 executes the first biometric authentication when processing the authentication request received from the main terminal 20.

The second biometric authentication is biometric authentication using at least the biometric information stored in the server device 10 and the authentication rule input to the server device 10 by the system administrator or the like. The server device 10 executes the second biometric authentication when processing the authentication request received from the subordinate terminal 30.

The server device 10 uses, for the second biometric authentication, information obtained as a result of the main terminal 20 providing the first service to the user who has succeeded in the first biometric authentication. That is, the second biometric authentication does not succeed unless the first biometric authentication is completed. From such a viewpoint, the main terminal 20 is a main authentication terminal in relation to the subordinate terminal 30. When the second biometric authentication succeeds, the subordinate terminal 30 provides the second service. The main terminal 20 corresponds to a first terminal, and the subordinate terminal 30 corresponds to a second terminal.

Which one of the “main terminal” and the “subordinate terminal” the authentication terminal included in the authentication system is set as may be set according to the industry type and policy of the business operator. That is, in the present disclosure, the “main terminal” and the “subordinate terminal” can be flexibly set.

The devices illustrated in FIG. 2 are connected to each other. For example, the server device 10 and the authentication terminal (Main terminal 20 and subordinate terminal 30) are connected by a wired or wireless communication means, and are configured to be able to communicate with each other.

FIG. 2 is an example and is not intended to limit the configuration and the like of the authentication system of the present disclosure. For example, the authentication system may include two or more server devices 10. The authentication system may include at least one or more main terminals 20 and at least one or more subordinate terminals 30.

In the first example embodiment, a case where the authentication system of the present disclosure is applied to a service provided at a hotel will be described, but it is not intended to limit the application of the authentication system to the hotel. Other applications will be described in the second example embodiment.

### [Outline Operation of System]

Next, a schematic operation of the authentication system according to the first example embodiment will be described.

### [User Registration]

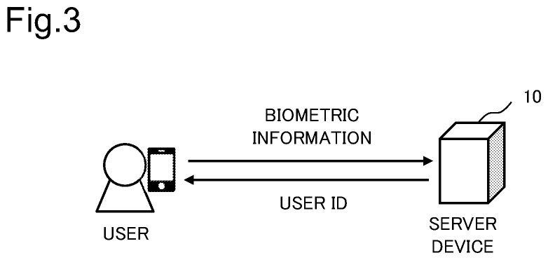

As illustrated in FIG. 3, the user who uses the authentication system performs user registration in advance. The user registers his/her own biometric information in the server device 10. For example, the user operates the possessed terminal to register the biometric information in the server device 10.

The biometric information about the user includes, for example, data (feature amount) calculated from physical characteristics unique to an individual, such as a pattern of a face, a fingerprint, a voiceprint, and a vein, a retina, and an iris of a pupil. Alternatively, the biometric information about the user may be image data such as a face image and a fingerprint image. The biometric information about the user may include the physical characteristics of the user as information. In the first example embodiment, the biometric information is a face image or a feature amount generated from the face image.

When acquiring the biometric information (for example, a face image), the server device 10 generates a user identifier (ID) for identifying the user. The server device 10 stores the biometric information about the user and the user ID in an authentication information database (DB; Database) in association with each other. The server device 10 stores the biometric information and the user ID about each of the plurality of users in association with each other using the authentication information database.

The server device 10 delivers the generated user ID to the user. More specifically, when the user registration succeeds, the server device 10 transmits the generated user ID to the terminal. The terminal stores the delivered user ID.

### [Input of Information Necessary for Service Provision]

The user who wants to receive the provision of the service by the biometric authentication inputs information necessary at that time to the system. For example, the user who wants to perform the check in procedure by biometric authentication inputs reservation information and the like to the hotel as the lodging destination. At this time, the user also inputs the user ID delivered from the server device 10 to the hotel.

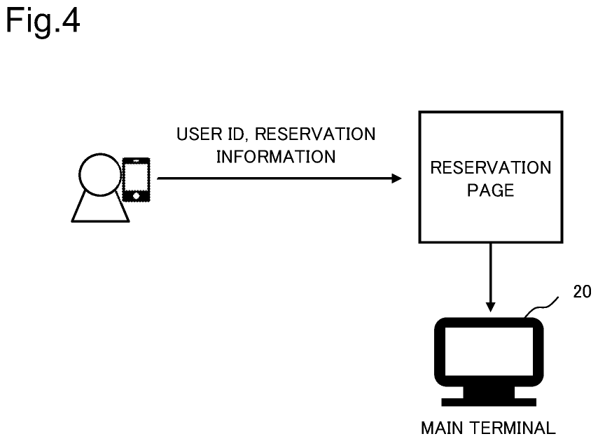

For example, as illustrated in FIG. 4, the user operates the terminal to access a web (web) page operated by the hotel. The user inputs a user ID and reservation information (for example, name, date of birth, gender, address, staying period, contact information, and the like) on the web page (hotel reservation page). The information input on the web page is registered in main terminal 20.

Main terminal 20 stores the user ID of the reservation holder and the reservation information in association with each other in the reservation holder information database.

The user who makes payment by biometric authentication inputs settlement information (for example, a bank account or a credit number for payment withdrawal) to the web page. The settlement information is registered in the subordinate terminal 30-2 requiring the information. The subordinate terminal 30-2 stores the user ID and the settlement information in association with each other.

### [Registration of Authentication Rule]

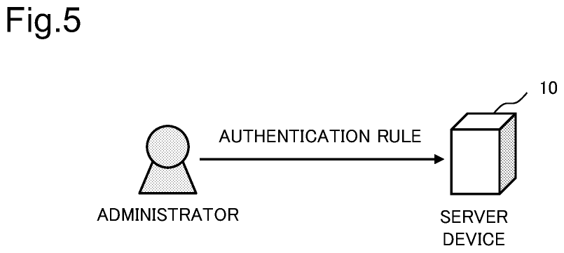

As described above, the administrator registers, in server device 10, the “authentication rule” for server device 10 to execute the second biometric authentication. The administrator designates the subordinate terminal 30 and registers the authentication rule in the server device 10 (see FIG. 5).

For example, the administrator registers, in the server device 10, a rule (condition) such as an “authenticatee whose check in is completed is considered to be successful in authentication” as the authentication rule related to the subordinate terminal 30-1. Alternatively, the administrator registers a rule such as an “authenticatee who is 20 years old or more is considered to be successful in authentication” in the server device 10 as the authentication rule related to the subordinate terminal 30-2.

The server device 10 stores the terminal ID of the subordinate terminal 30 and the authentication rule in the authentication rule management database in association with each other. The terminal ID is identification information for identifying an authentication terminal (main terminal 20 and subordinate terminal 30). The terminal ID can include a media access control (MAC) address, an internet protocol (IP) address, and the like of each authentication terminal. The terminal ID is shared between the server device 10 and the authentication terminal by an any means.

### [First Biometric Authentication]

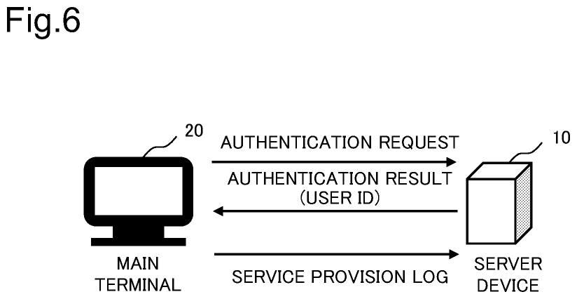

The first biometric authentication will be described with reference to FIG. 6.

For example, the user (guest) arriving at the hotel moves in front of the main terminal 20 installed in the counter. The main terminal 20 acquires biometric information (for example, a face image) about the user. The main terminal 20 transmits an “authentication request” including the acquired biometric information and terminal ID to the server device 10.

The server device 10 identifies the user by biometric authentication (collation processing) using the acquired biometric information and the preregistered biometric information. The server device 10 notifies the main terminal 20 of the user ID of the identified user. When authentication succeeds, the server device 10 transmits an affirmative response including the user ID to the main terminal 20.

The main terminal 20 provides a service to the user using the user ID acquired from the server device 10. Specifically, the main terminal 20 searches the reservation holder information database using the user ID as a key, and identifies related reservation information. The main terminal 20 performs the check-in procedure using the identified reservation information.

Upon completion of the first service (check in procedure), the main terminal 20 transmits a log registration request including the user ID of the user and log information (hereinafter, referred to as a service provision log) related to the service provision to the server device 10. For example, the main terminal 20 transmits, to the server device 10, the name, age, gender, and state (checked in) of the user as a service provision log.

The server device 10 stores the user ID and the service provision log in association with each other in the “log management database”.

### [Second Biometric Authentication]

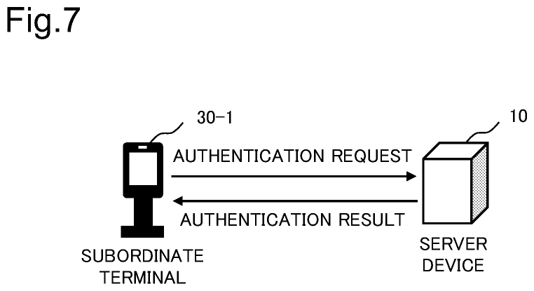

The second biometric authentication will be described with reference to FIG. 7.

For example, consider a case where the user moves from the entrance to the lodging area. In this case, the user receives biometric authentication in the subordinate terminal 30-1. The subordinate terminal 30-1 acquires biometric information (for example, a face image) of the user. The subordinate terminal 30-1 transmits an “authentication request” including the acquired biometric information and terminal ID to the server device 10.

The server device 10 identifies the user by biometric authentication (collation processing) using the acquired biometric information and the preregistered biometric information. Further, the server device 10 acquires an authentication rule preregistered based on the acquired terminal ID.

The server device 10 determines whether authentication succeeds or authentication fails based on the service provision log of the user identified by the collation processing and the authentication rule. For example, since the authentication rule related to the subordinate terminal 30-1 is an “authenticatee whose check in is completed is considered to be successful in authentication”, when the authenticatee completes the check in procedure, it is determined that authentication is successful.

On the other hand, when the user who has not completed the check in procedure tries to move to the lodging area, even when the biometric information about the user is registered in the server device 10, it is determined that the authentication has failed based on the authentication rule and the service provision log.

The server device 10 notifies the subordinate terminal 30-1 of an authentication result (authentication success, authentication failure). When the successful authentication is received, the subordinate terminal 30-1 opens the gate and permits the authenticatee to move to the lodging area. The subordinate terminal 30-1 provides the user with a second service of opening the gate. When the authentication failure is received, the subordinate terminal 30-1 closes the gate and refuses the authenticatee to move to the lodging area.

Next, details of each device included in the authentication system according to the first example embodiment will be described.

### [Server Device]

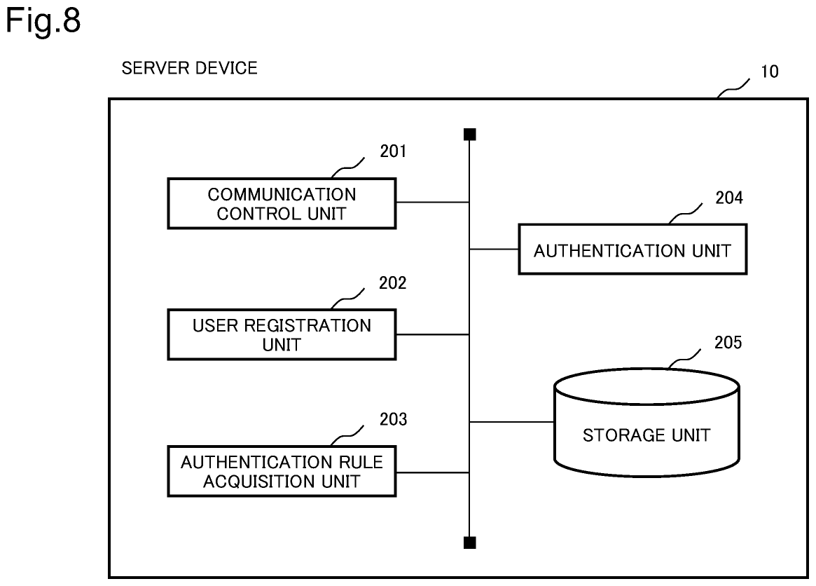

FIG. 8 is a diagram illustrating an example of a processing configuration (processing module) of the server device 10 according to the first example embodiment. Referring to FIG. 8, the server device 10 includes a communication control unit 201, a user registration unit 202, an authentication rule acquisition unit 203, an authentication unit 204, and a storage unit 205.

The communication control unit 201 is a means to control communication with another device. For example, the communication control unit 201 receives data (packet) from the main terminal 20. Furthermore, the communication control unit 201 transmits data to the main terminal 20. The communication control unit 201 delivers data received from another device to another processing module. The communication control unit 201 transmits data acquired from another processing module to another device. In this manner, the another processing module transmits and receives data to and from the another device via the communication control unit 201.

The user registration unit 202 is a means to achieve the user registration described above. The user registration unit 202 acquires the biometric information about the user using an any means. For example, the user registration unit 202 displays a graphical user interface (GUI) or an input form for acquiring the biometric information on the terminal, and acquires the biometric information (for example, a face image). Alternatively, the user who desires registration may transmit the external storage medium storing the biometric information to the management business operator of the server device 10, and an employee or the like of the business operator may input the biometric information to the server device 10 using the external storage medium.

The user registration unit 202 generates a feature amount (a feature vector including a plurality of feature amounts) from the acquired face image. An existing technique can be used for the feature amount generation process, and thus a detailed description of the process will be omitted. For example, the user registration unit 202 extracts eyes, a nose, a mouth, and the like as feature points from the face image. Thereafter, the user registration unit 202 calculates the position of each feature point and the distance between the feature points as a feature amount, and generates a feature vector (vector information characterizing the face image) including a plurality of feature amounts.

When the feature amount is successfully generated, the user registration unit 202 generates a user ID for uniquely identifying the user (registration desiring person). For example, the user registration unit 202 assigns a user ID each time user registration is performed.

When the feature amount is successfully generated, the user registration unit 202 transmits the generated user ID to the terminal.

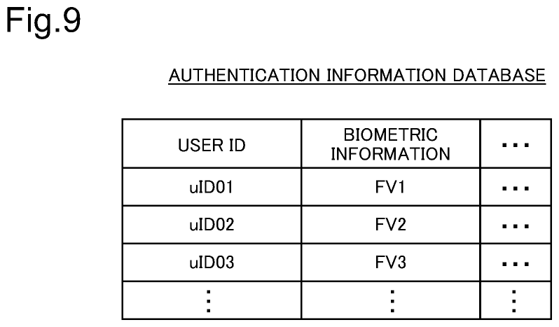

The user registration unit 202 stores the generated user ID and biometric information (for example, the feature amount) in the authentication information database (see FIG. 9). In this manner, the user registration unit 202 acquires the biometric information about each of the plurality of users, and stores the acquired biometric information in the authentication information database.

Note that the authentication information database illustrated in FIG. 9 is an example, and it is not intended to limit the items to be stored. For example, instead of or in addition to the feature amount, biometric information related to a face image may be stored in the authentication information database.

The authentication rule acquisition unit 203 is a means to acquire an authentication rule. The authentication rule includes a condition for determining that authentication is successful when processing the second authentication request.

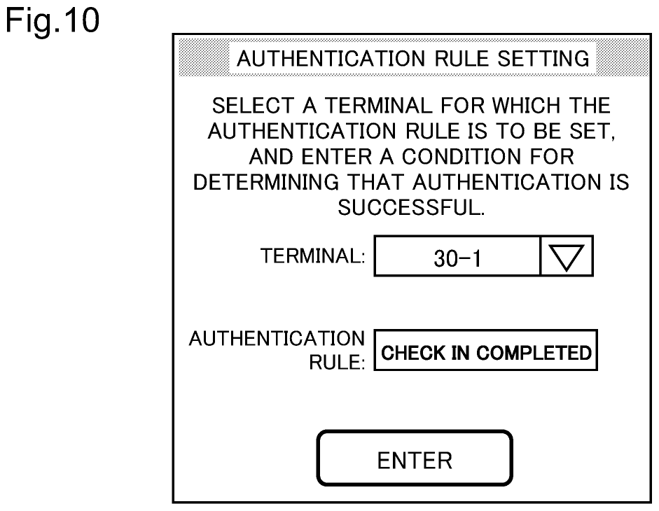

For example, the authentication rule acquisition unit 203 displays a GUI as illustrated in FIG. 10 in response to a request from an administrator or the like. The administrator designates the subordinate terminal 30 for which the authentication rule is set using the terminal ID, and inputs a rule (condition) for determining the authentication request from the subordinate terminal 30 as the authentication success.

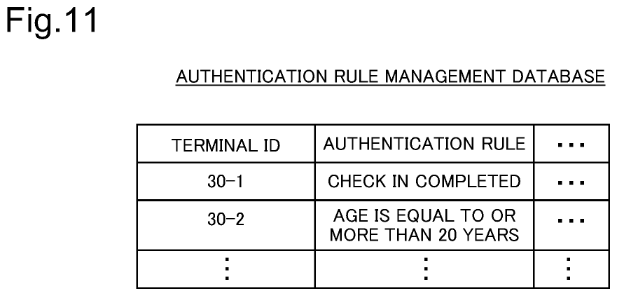

The authentication rule acquisition unit 203 stores the acquired terminal ID and the authentication rule in the authentication rule management database in association with each other (see FIG. 11). In the drawings including FIG. 11, for easy understanding, a reference sign assigned to each authentication terminal is described as a terminal ID.

Note that the authentication rule management database illustrated in FIG. 11 is an example, and it is not intended to limit the items to be stored. For example, the registration date and time of the authentication rule may be stored in the authentication rule management database.

The authentication unit 204 is a means to process the authentication request received from the authentication terminal and process the log registration request received from the main terminal 20.

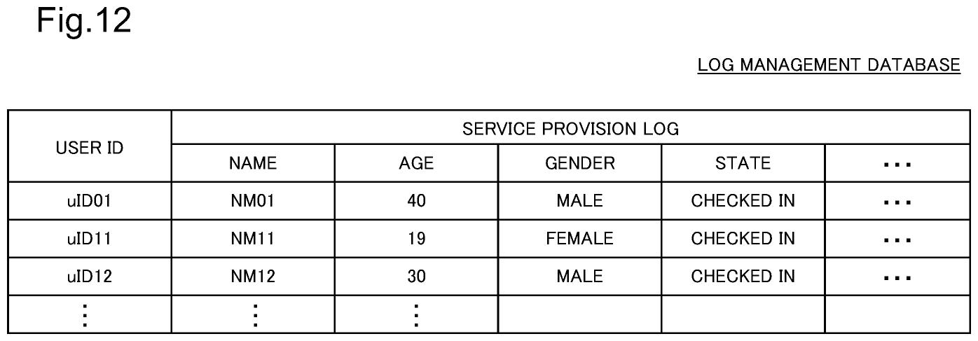

First, processing of the service provision log will be described. In response to the transmission of the result of the first biometric authentication to the main terminal 20, the authentication unit 204 acquires a service provision log obtained from the result of the provision of the service by the main terminal 20 to the user. More specifically, the authentication unit 204 receives the log registration request in response to notification of successful authentication to the main terminal 20. The authentication unit 204 registers the user ID and the service provision log included in the log registration request in the log management database (see FIG. 12).

The log management database illustrated in FIG. 12 is an example, and it is not intended to limit the items to be stored. For example, a date and time when the service provision log is received may be stored in the log management database.

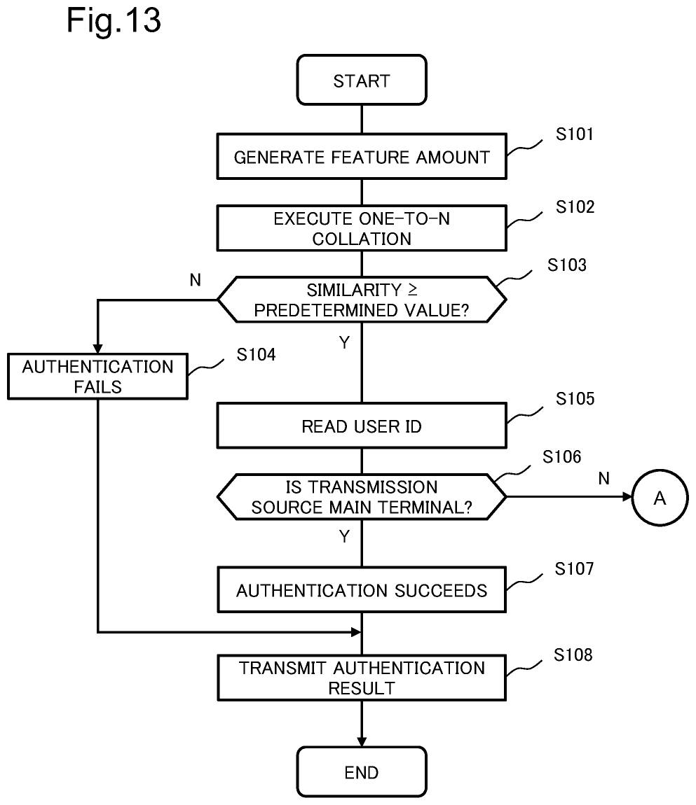

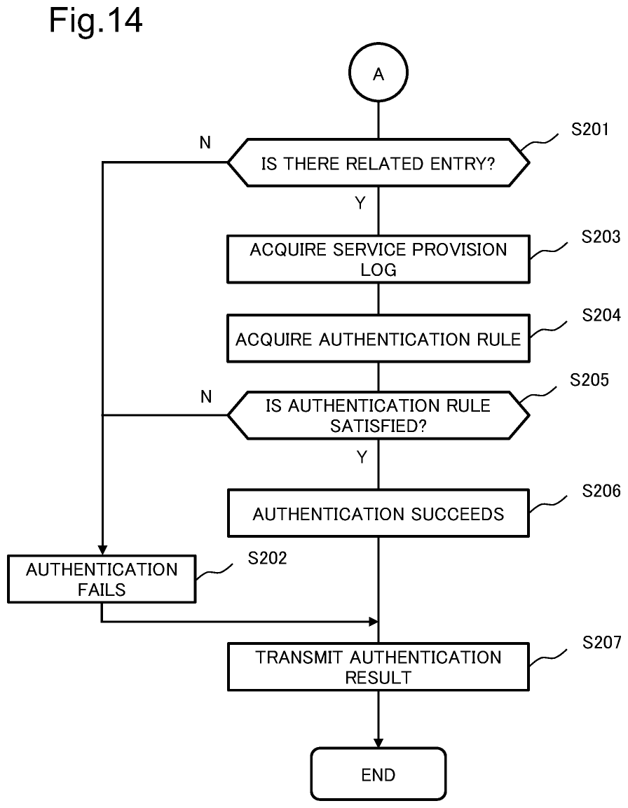

Next, the operation of the authentication unit 204 in a case where an authentication request is received from the authentication terminal will be described with reference to FIGS. 13 and 14. The authentication unit 204 performs first biometric authentication in response to the first authentication request transmitted from the main terminal 20, and performs second biometric authentication using an authentication rule in response to the second authentication request sent from the subordinate terminal 30. When the second biometric authentication is performed, the authentication unit 204 determines whether the condition described in the authentication rule is satisfied using the service provision log.

The authentication unit 204 extracts the biometric information (for example, a face image) from the received authentication request. The authentication unit 204 generates a feature amount from the extracted face image (step S101).

In step S102, the authentication unit 204 sets the generated feature amount as the collation side feature amount and the feature amounts stored in the authentication information database as the registration side feature amounts, and executes the one-to-N collation (N is a positive integer, and the same applies hereinafter). Specifically, the authentication unit 204 calculates similarity between the collation side feature amount and each of the plurality of the registration side feature amounts. As the similarity, a distance in a vector space, a distance in a probability distribution space, or the like can be used. The longer the distance is, the lower the degree of similarity is, and the distance is the shorter, the higher the degree of similarity is.

The authentication unit 204 determines whether there is a feature amount having similarity of a predetermined value or more to the feature amount to be collated among the plurality of feature amounts registered in the authentication information database (step S103).

When such a feature amount does not exist (step S103: No branch), the authentication unit 204 determines that the authentication has failed (step S104). That is, the authentication unit 204 determines that the authentication fails when the biometric information about the authenticatee is not registered in the authentication information database regardless of the type of biometric authentication.

When the feature amount as described above exists (step S103: Yes branch), the authentication unit 204 identifies an entry having a feature amount having the highest similarity to the collation side feature amount from the entries of the authentication information database, and reads the related user ID (step S105).

Next, the authentication unit 204 determines whether the transmission source of the authentication request is the main terminal 20 based on the terminal ID included in the authentication request (step S106).

When the transmission source of the authentication request is the main terminal 20 (step S106: Yes branch), the authentication unit 204 determines that the authentication request is for the first biometric authentication, and executes the processing in and after step S107.

When the transmission source of the authentication request is the subordinate terminal 30 (step S106: No branch), the authentication unit 204 determines that the authentication request is for the second biometric authentication, and executes the processing in and after step S201. The processing in and after step S201 is described in FIG. 14.

As described above, regardless of the first biometric authentication and the second biometric authentication, the authentication unit 204 sets the biometric information obtained from the authentication request as the collation side biometric information and sets the plurality of pieces of biometric information stored in the authentication information database as the registration side biometric information, and executes the one-to-N collation (N is a positive integer). Thereafter, the authentication unit 204 determines which of the first biometric authentication and the second biometric authentication is to be executed based on the terminal ID included in the authentication request.

In the case of the first biometric authentication, the authentication unit 204 determines that authentication is successful (step S107). That is, when processing the first biometric authentication, the authentication unit 204 determines that authentication is successful in a case where there is biometric information having similarity of a predetermined value or more to the collation side biometric information among the plurality of pieces of biometric information registered in the authentication information database.

The authentication unit 204 transmits the authentication result to the authentication terminal (main terminal 20) (step S108). When the authentication fails, the authentication unit 204 transmits a negative response indicating the failure to the main terminal 20. When the authentication is successful, the authentication unit 204 transmits an affirmative response including the user ID read in step S105 to the main terminal 20.

In the case of the second biometric authentication, the authentication unit 204 searches the log management database using the user ID read in step S105 as a key, and determines whether there is an entry related to the user ID (step S201 in FIG. 14).

When the related entry does not exist (step S201: No branch), the authentication unit 204 determines that the authentication fails (step S202). The fact that the related entry does not exist indicates that the service provision log necessary for the second biometric authentication is not transmitted to the server device 10, that is, the service provision in the main terminal 20 is not performed.

For example, in a case where a hotel reservation holder arrives at the hotel and arrives at the subordinate terminal 30 before completing the check in, the authentication failure may occur. More specifically, a user who has not completed check-in can not enter the lodging area, and a user whose age has not been confirmed can not purchase a product such as tobacco.

When the related entry exists (step S201: Yes branch), the authentication unit 204 acquires a service provision log of the related entry (step S203).

The authentication unit 204 searches the authentication rule management database using the terminal ID included in the authentication request as a key, and acquires the related authentication rule (step S204).

The authentication unit 204 determines whether the authenticatee (attribute and state of the authenticatee) satisfies the authentication rule based on the service provision log acquired in step S203 and the authentication rule acquired in step S204 (step S205).

When the authentication rule is satisfied (step S205: Yes branch), the authentication unit 204 determines that authentication is successful (step S206).

When the authentication rule is not satisfied (step S205: No branch), the authentication unit 204 determines that the authentication has failed (step S202).

For example, since the authentication rule of the subordinate terminal 30-1 is that the “authenticatee has completed check in” (see the first line of FIG. 11), authentication of the authenticatees related to the three user IDs illustrated in FIG. 12 succeeds.

Since the authentication rule of the subordinate terminal 30-2 is the “authenticatee is 20 years old or older” (see the second line of FIG. 11), the authentication of the authenticatees related to “uID01” and “uID 12” among the three user IDs illustrated in FIG. 12 succeeds. On the other hand, the authentication of the authenticatee related to the “uID 11” fails.

As described above, when processing the second biometric authentication, the authentication unit 204 determines that authentication is successful in a case where there is biometric information having similarity of a predetermined value or more to the collation side biometric information among a plurality of pieces of biometric information registered in the authentication information database, and the authentication rule is satisfied.

The authentication unit 204 transmits the authentication result to the authentication terminal (subordinate terminal 30) (step S207). When the authentication fails, the authentication unit 204 transmits a negative response indicating the failure to the subordinate terminal 30. When the authentication is successful, the authentication unit 204 transmits an affirmative response indicating the success to the subordinate terminal 30. The authentication unit 204 transmits an affirmative response including the user ID to the subordinate terminal 30 as necessary. In the example of FIG. 2, when notifying the subordinate terminal 30-2 of successful authentication, the authentication unit 204 transmits an affirmative response including the user ID to the subordinate terminal 30-2.

The storage unit 205 is a means to store information necessary for the operation of the server device 10. For example, the storage unit 205 stores table information that defines a relevant relationship between a terminal ID and an authentication terminal (main terminal 20 and subordinate terminal 30).

### [Main Terminal]

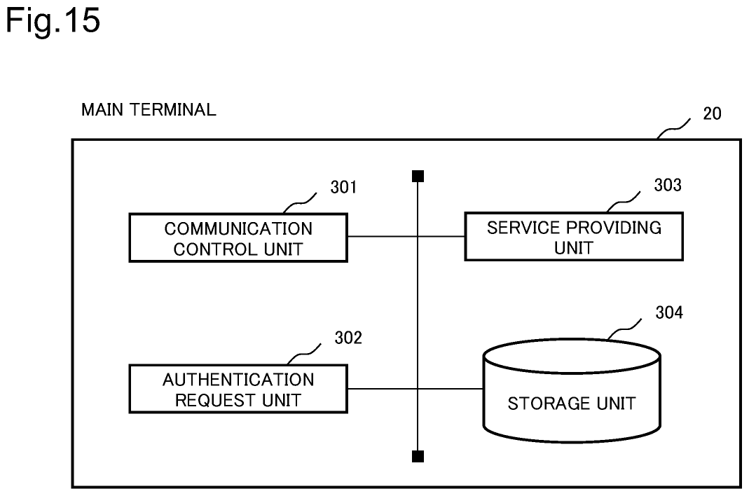

FIG. 15 is a diagram illustrating an example of a processing configuration (processing module) of the main terminal 20 according to the first example embodiment. Referring to FIG. 15, the main terminal 20 includes a communication control unit 301 an authentication request unit 302, a service providing unit 303, and a storage unit 304.

The communication control unit 301 is a means to control communication with another device. For example, the communication control unit 301 receives data (packet) from the server device 10. The communication control unit 301 transmits data to the server device 10. The communication control unit 301 delivers data received from another device to another processing module. The communication control unit 301 transmits data acquired from another processing module to another device. In this manner, the another processing module transmits and receives data to and from the another device via the communication control unit 301.

The authentication request unit 302 is a means to request the server device 10 to perform biometric authentication of the authenticatee. The authentication request unit 302 controls the camera to acquire biometric information (face image) of the user. More specifically, the authentication request unit 302 determines whether a face image of a person is included in the acquired image, and when a face image is included, a face image is extracted from the acquired image data.

An existing technique can be used for the face image extraction processing by the authentication request unit 302, and thus detailed description of the processing will be omitted. For example, the authentication request unit 302 may extract a face image (face region) from image data by using a learning model learned by a convolutional neural network (CNN). Alternatively, the authentication request unit 302 may extract the face image using a method such as template matching.

The authentication request unit 302 transmits an authentication request including the extracted face image (biometric information) and the terminal ID of the host device to the server device 10.

The authentication request unit 302 acquires an authentication result (authentication success, authentication failure) from the server device 10.

When the authentication fails, the authentication request unit 302 notifies the authentication failure person (the authenticatee for which authentication is determined to be failure) of the failure.

When the authentication is successful, the authentication request unit 302 delivers the user ID included in the affirmative response to the service providing unit 303.

The service providing unit 303 is a means to provide a service to an authentication successful person. As illustrated in FIG. 2, in a case where the main terminal 20 is a terminal for performing a check in procedure, the service providing unit 303 performs a check in procedure of an authentication successful person.

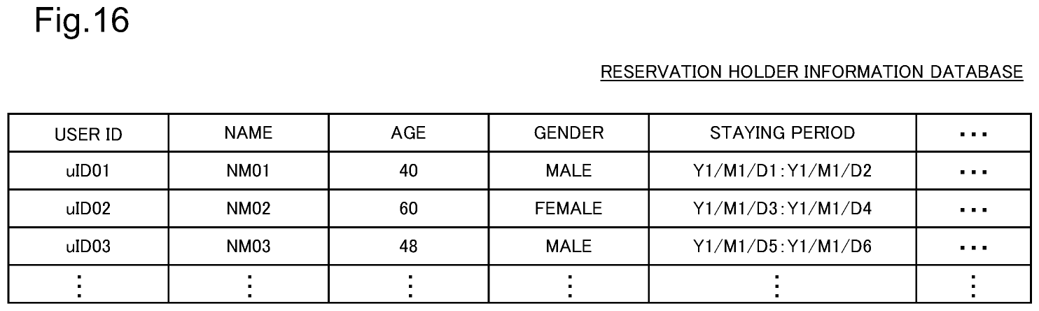

Specifically, the service providing unit 303 searches the reservation holder information database (see FIG. 16) using the user ID acquired from the server device 10 as a key, and identifies a related entry (reservation holder). The service providing unit 303 performs a check in procedure based on reservation holder information about the identified reservation holder. For example, the service providing unit 303 confirms whether the arrival date of the reservation holder is included in the staying period of the reservation information, and performs the check in procedure.

When providing a service to the user, the service providing unit 303 notifies the server device 10 of information resulting from the provision of the service as a service provision log. More specifically, the service providing unit 303 transmits, to the server device 10, a log registration request including the user ID of the user to whom the service was provided and the service provision log.

In the example of the check-in procedure, the service providing unit 303 transmits, to the server device 10, information indicating that the check-in is completed (the state of the user) in addition to the name, age, gender, and the like of the user as a service provision log.

The storage unit 304 is a unit means to store information necessary for the operation of the main terminal 20. The reservation holder information database is constructed in the storage unit 304. Acquisition or the like of items stored in the reservation holder information database is different from the gist of the disclosure of the present disclosure and is obvious to those of ordinary skill, and thus detailed description thereof will be omitted.

### [Subordinate Terminal]

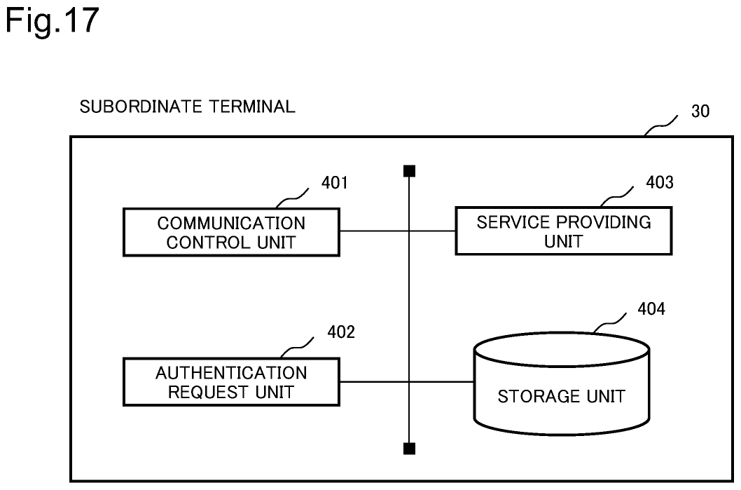

FIG. 17 is a diagram illustrating an example of a processing configuration (processing module) of the subordinate terminal 30 according to the first example embodiment. Referring to FIG. 17, the subordinate terminal 30 includes a communication control unit 401, an authentication request unit 402, a service providing unit 403, and a storage unit 404.

Since the basic operation of each processing module included in the subordinate terminal 30 can be the same as the operation of each processing module included in the main terminal 20, a detailed description of the operation will be omitted. However, the service providing unit 403 does not need to transmit the “service provision log” to the server device 10.

### [Operation of System]

Next, an operation of the authentication system according to the first example embodiment will be described. Description of operations related to user registration and authentication rule registration will be omitted.

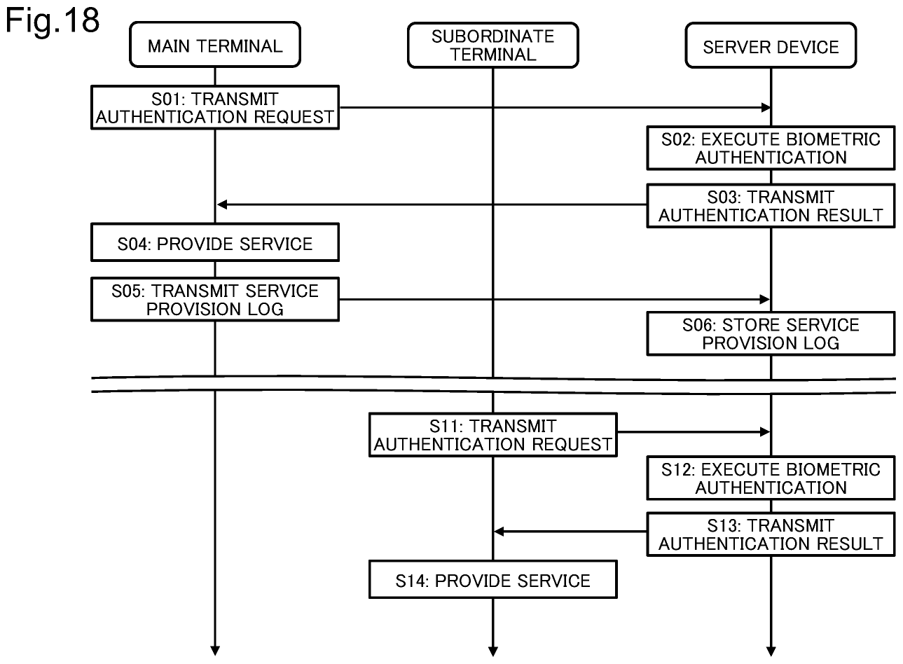

FIG. 18 is a sequence diagram illustrating an example of the operation of the authentication system according to the first example embodiment.

The main terminal 20 acquires the biometric information about the authenticatee to transmit an authentication request including the biometric information to the server device 10 (step S01).

The server device 10 executes the biometric authentication using the biometric information included in the acquired authentication request and the biometric information registered in advance (step S02).

Server device 10 transmits the result of the biometric authentication to main terminal 20 (step S03).

When the biometric authentication succeeds, the main terminal 20 provides the first service to the user (step S04).

The main terminal 20 transmits a service provision log obtained from a result of service provision to the server device 10 (step S05).

The server device 10 stores the received service provision log (step S06).

The subordinate terminal 30 acquires the biometric information about the authenticatee to transmit an authentication request including the biometric information to the server device 10 (step S11).

The server device 10 executes the biometric authentication using the biometric information included in the acquired authentication request and the biometric information registered in advance (step S12). At this time, the server device 10 determines the result of the authentication process (authentication success, authentication failure) using the service provision log acquired from the main terminal 20 and the authentication rule related to the subordinate terminal 30.

The server device 10 transmits the result of the biometric authentication to the subordinate terminal 30 (step S13).

When the biometric authentication succeeds, the subordinate terminal 30 provides the second service to the user (step S14).

As described above, in the authentication system according to the first example embodiment, the administrator registers, in the server device 10, an authentication rule for determining that the authentication of the subordinate terminal 30 is successful. The server device 10 grasps an action, an attribute, a state, and the like of the authenticatee from the service provision log received from the main terminal 20. For example, the server device 10 grasps whether the authenticatee has completed the check in procedure or the like via the service provision log. When the action or the like of the user matches an action assumed to be an “authentication success” by the administrator, the server device 10 determines that the authentication from the subordinate terminal 30 has succeeded and enables service provision from the subordinate terminal 30. The administrator can determine the authentication rule while considering the convenience of the user and the security of the system.

### Second Example Embodiment

Next, the second example embodiment will be described.

In the first example embodiment, the authentication system of the present disclosure is described using a hotel as an example. In the first example embodiment, it is described that the main terminal 20 provides the first service (for example, a check in procedure) to the user, and the subordinate terminal 30 provides the second service (for example, entrance to lodging area, payment).

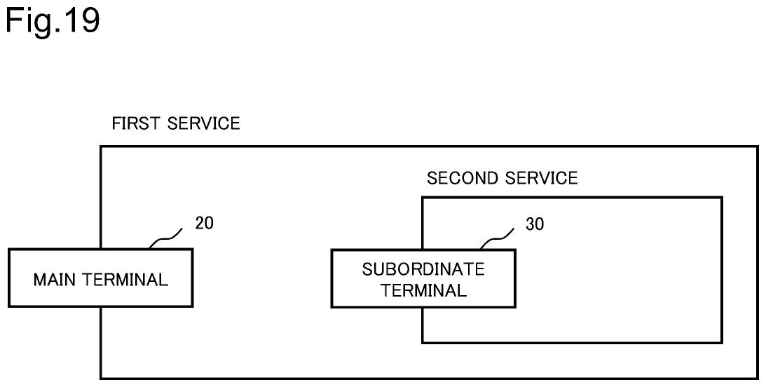

In the second example embodiment, other specific examples of the relationship between the main terminal 20 and the subordinate terminal 30 and the provision of the second service after the provision of the first service will be described. That is, in the second example embodiment, specific examples of the main terminal 20, the subordinate terminal 30, the first service, and the second service as illustrated in FIG. 19 will be described.

### First Specific Example

The authentication system of the present disclosure can be used for access restriction in a building such as a building. Specifically, the main terminal 20 described above is a terminal that controls opening and closing of a gate set at an entrance of a building. The subordinate terminal 30 is a terminal that controls opening and closing of a gate set at an entrance of a workplace. The administrator sets the “authentication of the main terminal 20 is successful” in the server device 10 as the authentication rule of the subordinate terminal 30. When the authentication of the user (employee) succeeds, the main terminal 20 transmits a service provision log including the authentication date and time, the employee number, and the like to the server device 10. When processing the authentication request from the subordinate terminal 30, the server device 10 determines that authentication is successful in a case where the authenticatee passes through the entrance of the building (authentication in the main terminal 20 is successful).

### Second Specific Example

The authentication system of the present disclosure can be used for boarding control of an aircraft, a vessel, or the like. Specifically, the above-described main terminal 20 is a terminal that controls opening and closing of an entrance gate of an airport or the like. The subordinate terminal 30 is a terminal that controls opening and closing of a boarding gate when boarding the aircraft. The administrator sets the “authentication of the main terminal 20 is successful” in the server device 10 as the authentication rule of the subordinate terminal 30. When the authentication of the user (passenger) succeeds, the main terminal 20 transmits the service provision log including the authentication date and time, the passport number, and the like to server device 10. When processing the authentication request from the subordinate terminal 30, the server device 10 determines that authentication is successful in a case where the authenticatee has passed through the entrance gate of the airport (authentication in the main terminal 20 as succeeded).

### Third Specific Example

The authentication system of the present disclosure can be used for entrance control to an event venue or the like. Specifically, the above-described main terminal 20 is a terminal that controls opening and closing of an entrance gate of an event venue or the like. The subordinate terminal 30 is a terminal that provides a service related to an event. For example, the subordinate terminal 30 is a terminal that controls opening and closing of a gate installed at an entrance of a waiting space (waiting room) of an event venue. The administrator sets the “user is a very important person (VIP) member” in the server device 10 as an authentication rule of the subordinate terminal 30. When the authentication of the user (event participant) succeeds, the main terminal 20 transmits the service provision log including the authentication date and time, the ticket number, the membership number, and the like to the server device 10. When processing the authentication request from the subordinate terminal 30, the server device 10 determines that authentication is successful when determining that the user is a VIP based on the membership number.

### Fourth Specific Example

The authentication system of the present disclosure can be used to restrict use of information processing devices such as personal computers. Specifically, the main terminal 20 described above is a terminal that controls opening and closing of an entrance gate of an office. The subordinate terminal 30 is a personal computer. The manager sets “use within working hours by employees other than the manager” in the server device 10 as the authentication rule of the subordinate terminal 30. When the authentication of the user (employee) succeeds, the main terminal 20 transmits a service provision log including the authentication date and time, the employee number, and the like to the server device 10. When processing the authentication request from the subordinate terminal 30, the server device 10 determines whether the authentication rule is satisfied from the authentication date and time and the employee number.

### Fifth Specific Example

The authentication system of the present disclosure can be used to restrict use of a vehicle such as a rental car. Specifically, the main terminal 20 described above is assumed to be a terminal installed in a car rental office. The main terminal 20 is a terminal for subscribing to a rental car. The subordinate terminal 30 is a rental car. The administrator sets “completion of car rental contract” in the server device 10 as an authentication rule of the subordinate terminal 30. When the authentication of the user succeeds, the main terminal 20 transmits a service provision log including a contract status and the like to the server device 10. When processing the authentication request from the subordinate terminal 30, the server device 10 determines whether the rental car contract of the user is completed.

As described above, as described in the second example embodiment, the authentication system of the present disclosure can be applied not only to the biometric authentication of the hotel but also to an any place such as an airport or an event venue.

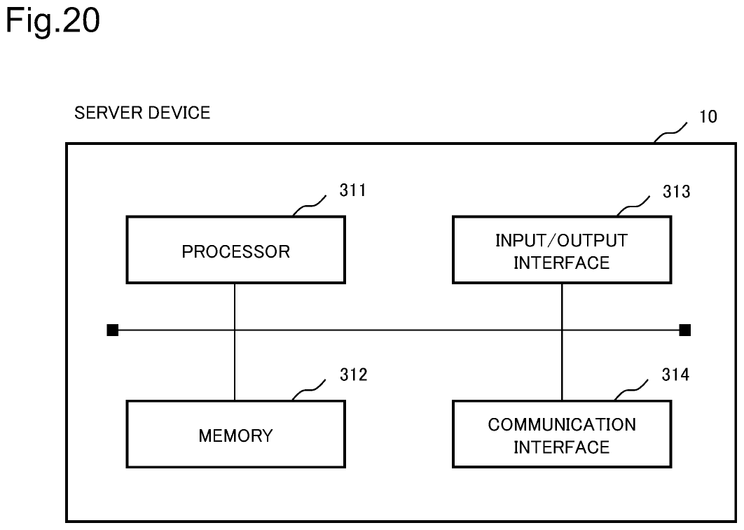

Next, hardware of each device constituting the authentication system will be described. FIG. 20 is a diagram illustrating an example of a hardware configuration of the server device 10.

The server device 10 can be configured by an information processing device (so-called computer), and has the configuration illustrated in FIG. 20. For example, the server device 10 includes a processor 311, a memory 312, an input/output interface 313, a communication interface 314, and the like. The components such as the processor 311 are connected by an internal bus or the like and are configured to be able to communicate with each other.

However, the configuration illustrated in FIG. 20 is not intended to limit the hardware configuration of the server device 10. The server device 10 may include hardware not illustrated or may not include the input/output interface 313 as necessary. The number of processors 311 and the like included in the server device 10 is not limited to the example of FIG. 20, and for example, a plurality of processors 311 may be included in the server device 10.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various kinds of programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The functions of the server device 10 are implemented by various processing modules. The processing module is implemented, for example, by the processor 311 executing a program stored in the memory 312. The program can be recorded in a computer-readable storage medium. The storage medium may be a non-transient medium such as a semiconductor memory, a hard disk, a magnetic recording medium, or an optical recording medium. That is, the present invention can also be embodied as a computer program product. The program can be downloaded via a network or updated using a storage medium storing the program. Furthermore, the processing module may be achieved by a semiconductor chip.

The main terminal 20 and the subordinate terminal 30 can also be configured by an information processing device as in the server device 10, and have no difference in the basic hardware configuration from the server device 10, so that the description thereof will be omitted. For example, the authentication terminal (main terminal 20 and subordinate terminal 30) may include a camera for imaging the user.

The server device 10 that is an information processing device includes a computer, and can implement the function of the server device 10 by causing the computer to execute a program. In addition, the server device 10 executes the biometric authentication method by the program.

### [Modification]

The configuration, operation, and the like of the authentication system described in the above example embodiment are merely examples, and are not intended to limit the configuration and the like of the system.

In the above example embodiment, the configuration in which the server device 10 includes the authentication information database and the authentication rule management database is described. However, these databases may be constructed in a database server different from the server device 10 or the like. The authentication system may include various means (the authentication unit 204 and the like) described in the above example embodiment.

The main terminal 20 may guide the user to a service or the like that is available in response to successful authentication on the terminal. For example, the main terminal 20 may guide the user who has completed the check in procedure that the user can enter the lodging building or each room by biometric authentication or make a payment by biometric authentication at a store or a restaurant. Alternatively, the main terminal 20 may map and display a place where the subordinate terminal 30 for receiving the biometric authentication is installed.

Alternatively, the subordinate terminal 30 may present a cause of the authentication failure in the terminal to the user, and may guide the user to receive the biometric authentication in the main terminal 20. For example, when the user who has not completed the check in procedure performs the biometric authentication in each room and the authentication fails, the subordinate terminal 30 guides the user to complete the check in procedure in the main terminal 20. At this time, the subordinate terminal 30 may map and display an installation place of the main terminal 20.

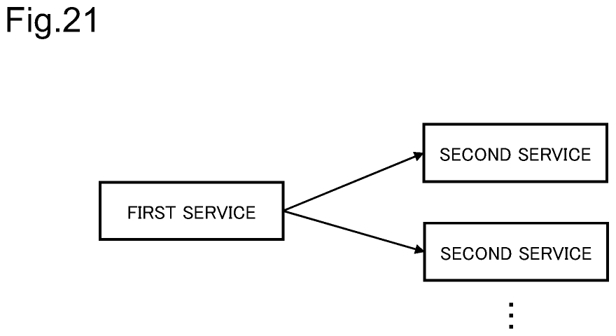

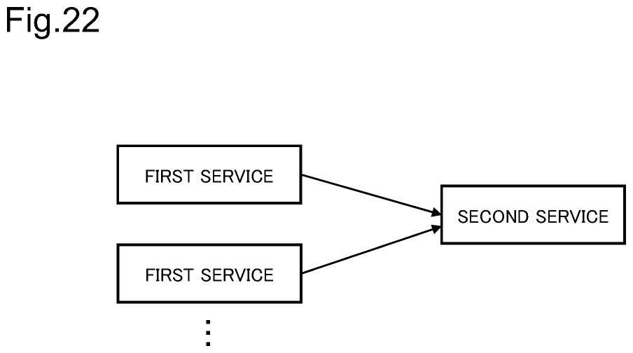

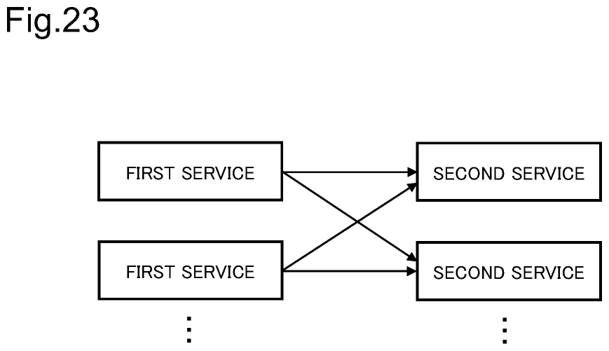

A relationship between the first service and the second service is not limited to one-to-one. As described in the first example embodiment, a plurality of second services may be provided related to one first service (see FIG. 21). Alternatively, as illustrated in FIG. 22, one second service may be provided related to a plurality of first services. Alternatively, as illustrated in FIG. 23, a plurality of second services may be provided related to a plurality of first services. That is, the relationship between the first service and the second service may be any relationship as long as the second service is provided after the first service is provided.

In the above example embodiment, the configuration of a so-called client server system related to biometric authentication is described. However, the biometric authentication can be completed by the authentication terminal (main terminal 20 and subordinate terminal 30) alone.

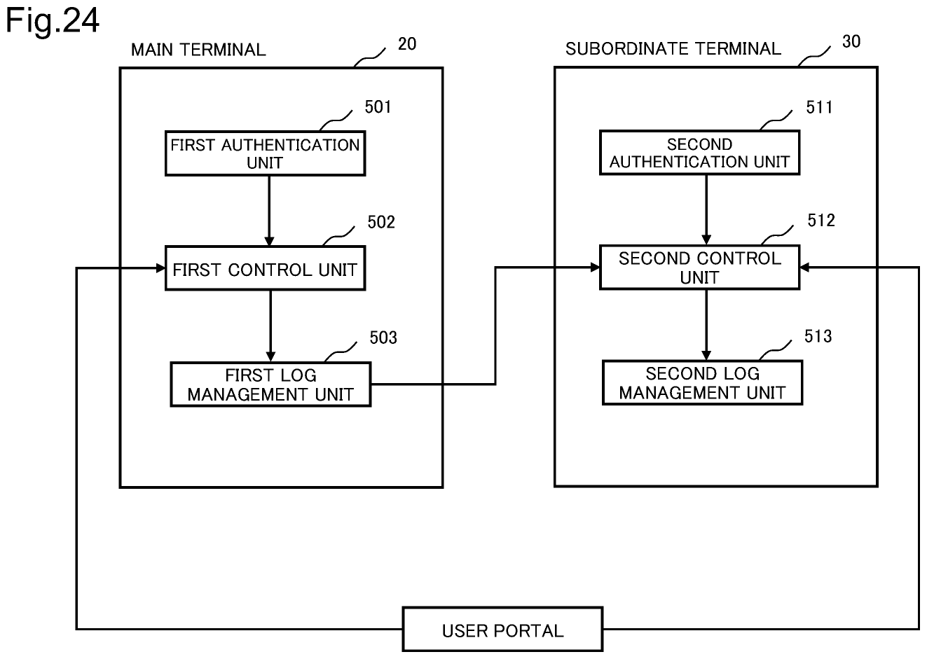

In this case, for example, a configuration as illustrated in FIG. 24 is used. The main terminal 20 includes a first authentication unit 501, a first control unit 502, and a first log management unit 503. The subordinate terminal 30 includes a second authentication unit 511, a second control unit 512, and a second log management unit 513. The user inputs information (biometric information, reservation information, and the like) necessary for receiving service provision to the authentication terminal via the user portal (web page). The second control unit 512 acquires the authentication rule. The first authentication unit 501 and the second authentication unit 511 perform biometric authentication. The first control unit 502 and the second control unit 512 provide services to the user. For example, the first control unit 502 performs a check in procedure, and the second control unit 512 performs gate opening/closing control. The first log management unit 503 transmits a service provision log obtained from a result of service provision to the second control unit 512. The second control unit 512 determines whether the service can be provided according to the service provision log and the authentication rule. The second log management unit 513 collects log information obtained from a result of service provision.

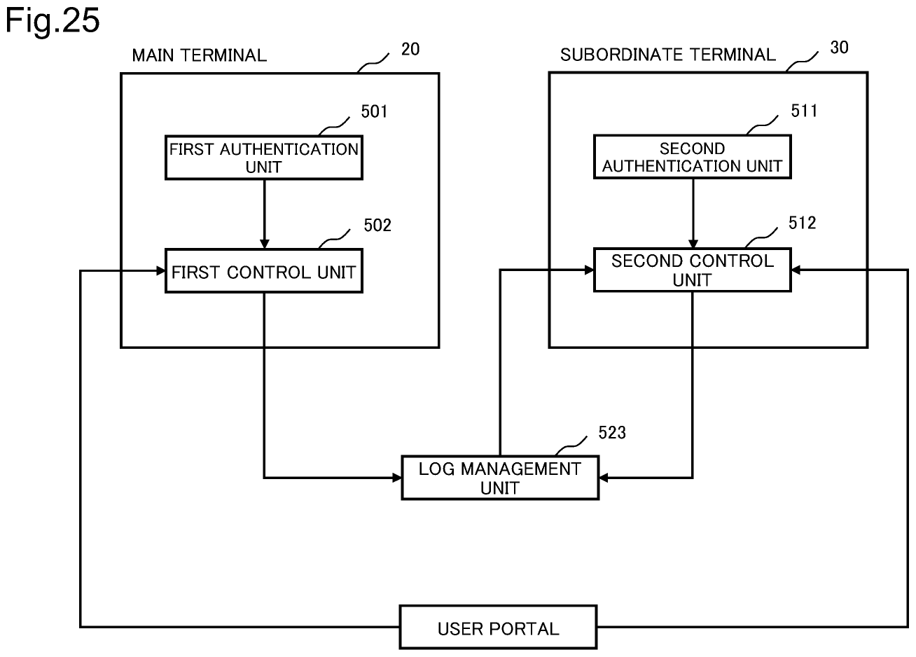

Alternatively, the main terminal 20 and the subordinate terminal 30 may have a configuration as illustrated in FIG. 25. That is, the function of the log management unit of each authentication terminal may be implemented by an external device. In this case, a log management unit 523 collects, manages, and controls log information obtained from the main terminal 20 and the subordinate terminal 30.

The server device 10 may confirm the identity of the user at the time of user registration. Specifically, the server device 10 acquires an identity confirmation document (document containing biometric information; for example, the passport) in addition to the biometric information about the user from the terminal. In a case where the one-to-one collation using the acquired biometric information and the biometric information acquired from the identity confirmation document succeeds, the server device 10 determines that the identification of the user is successful. The server device 10 may register the biometric information about the user in a case where the identification confirmation succeeds.

In the above embodiment, a case where the biometric information related to the “face image” is transmitted from the authentication terminal to the server device 10 has been described. However, the biometric information related to the “feature amount generated from the face image” may be transmitted from the authentication terminal to the server device 10. In this case, the server device 10 can omit the feature amount generation processing.

In the above example embodiment, a case where it is determined whether the authentication rule is satisfied based on one item included in the service provision log is described. However, it may be determined whether the authentication rule is satisfied based on a plurality of items included in the service provision log. For example, the authentication rule may be the “check in of the authenticatee is completed, and the age is equal to or more than 20 years”. Alternatively, one authentication terminal and a plurality of authentication rules may be stored in association with each other, and the server device 10 may perform biometric authentication according to a logical product (AND) or a logical sum (OR) of the plurality of authentication rules.

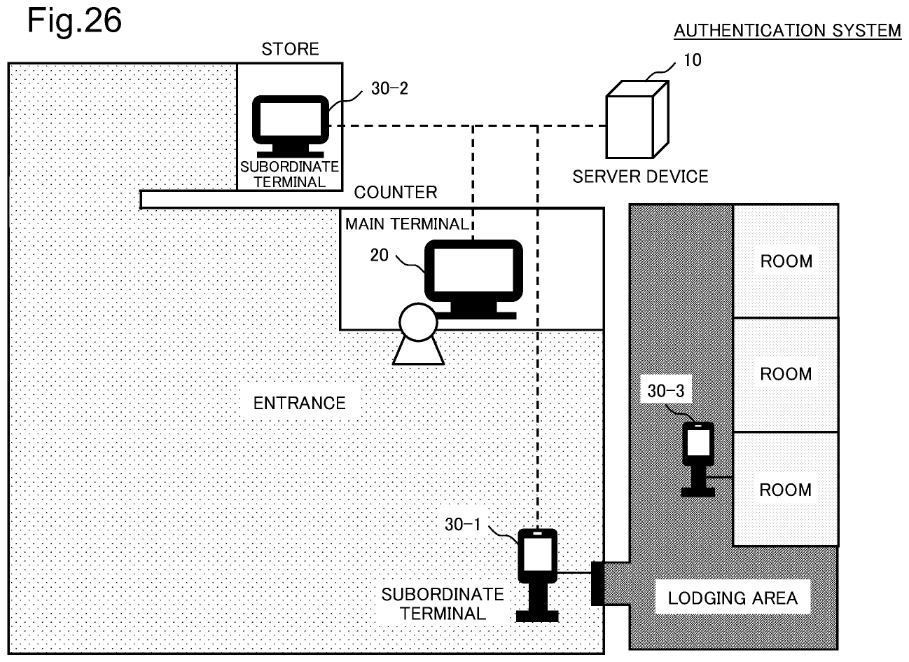

One authentication terminal may serve as the main terminal 20 and the subordinate terminal 30. For example, as illustrated in FIG. 26, it is considered that a subordinate terminal 30-3 unlocks the room in the lodging area. In this case, the administrator sets the authentication rule related to the subordinate terminal 30-3 to “authentication of the subordinate terminal 30-1 is successful”. The subordinate terminal 30-1 transmits, to the server device 10, the user ID of the authentication successful person and the authentication date and time as a service provision log. When processing the authentication request from the subordinate terminal 30-3, the server device 10 refers to the service provision log received from the subordinate terminal 30-1 and the authentication rule acquired from the administrator. In such a configuration, the subordinate terminal 30-1 operates as a “main terminal” for the subordinate terminal 30-3.

In the above example embodiment, the case where the administrator or the like of the system inputs the authentication rule to the server device 10 is described. However, the authentication rule may be input to the server device 10 by a user (authenticatee, general consumer). With such a response, the convenience of the user can be further enhanced. For example, there is a traveler who is concerned about the risk of unauthorized use of biometric information and wants to use biometric authentication only at a travel destination. Such a traveler may want to enjoy appropriate convenience according to a period, a target region, a target product, and a service after recognizing a certain risk. In such a case, when the traveler himself/herself can set a rule to be the available condition in advance and update the rule on demand, the convenience and satisfaction of the user are improved. Alternatively, by inputting the authentication rule by the user himself/herself, a change may be made in which a threshold value of the degree of similarity for determining whether authentication is successful in a case where a rule serving as an available condition is activated is changed, or in which verification of biometrics (liveness) is added in addition to biometric authentication.

Although it is clear from the above description that the authentication rule includes a rule as to whether to determine that biometric authentication is successful (a rule as to whether authentication can be performed), the authentication rule may include a rule related to an operation after authentication succeeds (a rule that operates according to a state after authentication). For example, consider a case where the entrance/exit gat (subordinate terminal 30-1) has a signage function (guidance display by signage). The authentication rule related to the entrance/exit gat may include a setting such as “prompting check in when the authenticatee has not completed the check in procedure”.

A form of data transmission and reception between the devices (server device 10, main terminal 20, and subordinate terminal 30) is not particularly limited, but data transmitted and received between these devices may be encrypted. Biometric information is transmitted and received between these devices, and it is desirable that encrypted data is transmitted and received in order to appropriately protect the biometric information.

In the flow chart (flowchart and sequence diagram) used in the above description, a plurality of steps (processes) is described in order, but the execution order of the steps executed in the example embodiment is not limited to the described order. In the example embodiment, for example, the order of the illustrated steps can be changed within a range in which there is no problem in terms of content, such as executing each step in parallel.

The above example embodiments have been described in detail in order to facilitate understanding of the present disclosure, and it is not intended that all the configurations described above are necessary. In a case where a plurality of example embodiments is described, each example embodiment may be used alone or in combination. For example, part of the configuration of the example embodiment can be replaced with the configuration of another example embodiment, or the configuration of another example embodiment can be added to the configuration of the example embodiment. Furthermore, it is possible to add, delete, and replace other configurations for part of the configuration of the example embodiment.

Although the industrial applicability of the present invention is apparent from the above description, the present invention can be suitably applicable to an authentication system of a hotel or the like in which a plurality of authentication terminals is installed.

Some or all of the above example embodiments may be described as the following Supplementary Notes, but are not limited to the following.

### [Supplementary Note 1]

A server device including
an acquisition unit that acquires an authentication rule including a condition for determining that authentication is successful, and
an authentication unit that performs first biometric authentication in response to a first authentication request transmitted from a first terminal and performs second biometric authentication using the authentication rule in response to a second authentication request transmitted from a second terminal.

### [Supplementary Note 2]

The server device according to Supplementary Note 1, wherein the authentication unit acquires a service provision log obtained from a result of provision of a service by the first terminal in response to transmission of a result of the first biometric authentication to the first terminal.

### [Supplementary Note 3]

The server device according to Supplementary Note 2, wherein the authentication unit determines whether the authentication rule is satisfied using the service provision log when executing the second biometric authentication.

### [Supplementary Note 4]

The server device according to any one of Supplementary Notes 1 to 3, further including a user registration unit that acquires biometric information about each of a plurality of users and stores the acquired biometric information in an authentication information database.

### [Supplementary Note 5]

The server device according to Supplementary Note 4, wherein the authentication unit sets biometric information obtained from the first authentication request or the second authentication request as collation side biometric information and sets a plurality of pieces of biometric information stored in the authentication information database as registration side biometric information, and executes one-to-N collation where N is a positive integer.

### [Supplementary Note 6]

The server device according to Supplementary Note 5, wherein, when the first biometric authentication is processed, the authentication unit determines that authentication is successful in a case where there is biometric information having similarity of a predetermined value or more to the collation side biometric information among the plurality of pieces of biometric information registered in the authentication information database.

### [Supplementary Note 7]

The server device according to Supplementary Note 5 or 6, wherein, when the second biometric authentication is processed, the authentication unit determines that authentication is successful in a case where there is biometric information having similarity of a predetermined value or more to the collation side biometric information among a plurality of pieces of biometric information registered in the authentication information database and the authentication rule is satisfied.

### [Supplementary Note 8]

The server device according to any one of Supplementary Notes 1 to 7, wherein the authentication unit determines which of the first biometric authentication and the second biometric authentication is to be executed based on a terminal ID included in the first authentication request and the second authentication request.

### [Supplementary Note 9]

The server device according to any one of Supplementary Notes 4 to 7, wherein the biometric information is a face image or a feature amount generated from the face image.

### [Supplementary Note 10]

A system including
a first terminal,
a second terminal, and
a server device connected to the first and second terminals, wherein
the server device includes
an acquisition unit that acquires an authentication rule including a condition for determining that authentication is successful, and
an authentication unit that performs first biometric authentication in response to a first authentication request transmitted from the first terminal and performs second biometric authentication using the authentication rule in response to a second authentication request transmitted from the second terminal.

### [Supplementary Note 11]

A biometric authentication method including
a server device
acquiring an authentication rule including a condition for determining that authentication is successful, and
performing first biometric authentication in response to a first authentication request transmitted from a first terminal and performing second biometric authentication using the authentication rule in response to a second authentication request transmitted from a second terminal.

### [Supplementary Note 12]

A non-transitory computer-readable storage medium storing a program for causing a computer mounted on a server device to execute
a step of acquiring an authentication rule including a condition for determining that authentication is successful, and
a step of performing first biometric authentication in response to a first authentication request transmitted from a first terminal and performing second biometric authentication using the authentication rule in response to a second authentication request transmitted from a second terminal.

The disclosures of the cited prior art documents are incorporated herein by reference. While the exemplary example embodiments of the present invention have been described, the present invention is not limited to these example embodiments. It will be understood by those of ordinary skill in the art that these example embodiments are exemplary only and that various variations may be made therein without departing from the scope and spirit of the present invention as defined by the claims. That is, it goes without saying that the present invention includes various modifications and corrections that can be made by those of ordinary skill in the art in accordance with the entire disclosure including the claims and the technical idea.

### REFERENCE SIGNS LIST

10, 100 server device
20 main terminal
30, 30-1 to 30-3 subordinate terminal
101 acquisition unit
102, 204 authentication unit
201, 301, 401 communication control unit
202 user registration unit
203 authentication rule acquisition unit
205, 304, 404 storage unit
302, 402 authentication request unit
303, 403 service providing unit
311 processor
312 memory
313 input/output interface
314 communication interface
501 first authentication unit
502 first control unit
503 first log management unit
511 second authentication unit
512 second control unit
513 second log management unit
523 log management unit

What is claimed is:

1. A server device comprising:
a memory configured to store instructions; and
at least one processor configured to execute the instructions to perform:
acquiring an authentication rule including a condition for determining that authentication is successful; and
performing first biometric authentication in response to a first authentication request transmitted from a first terminal and performs second biometric authentication using the authentication rule in response to a second authentication request transmitted from a second terminal.

2. The server device according to claim 1, wherein
the at least one processor is configured to execute the instructions to perform:
acquiring a service provision log obtained from a result of provision of a service by the first terminal in response to transmission of a result of the first biometric authentication to the first terminal.

3. The server device according to claim 2, wherein
the at least one processor is configured to execute the instructions to perform:
determining whether the authentication rule is satisfied using the service provision log when executing the second biometric authentication.

4. The server device according to claim 1, wherein
the at least one processor is further configured to execute the instructions to perform:
acquiring biometric information about each of a plurality of users and stores the acquired biometric information in an authentication information database.

5. The server device according to claim 4, wherein
the at least one processor is configured to execute the instructions to perform:
setting biometric information obtained from the first authentication request or the second authentication request as collation side biometric information and sets a plurality of pieces of biometric information stored in the authentication information database as registration side biometric information, and executes one-to-N collation where N is a positive integer.

6. The server device according to claim 5, wherein,
the at least one processor is configured to execute the instructions to perform: when the first biometric authentication is processed, determining that authentication is successful in a case where there is biometric information having similarity of a predetermined value or more to the collation side biometric information among the plurality of pieces of biometric information registered in the authentication information database.

7. The server device according to claim 5, wherein,
the at least one processor is configured to execute the instructions to perform:
when the second biometric authentication is processed, determining that authentication is successful in a case where there is biometric information having similarity of a predetermined value or more to the collation side biometric information among the plurality of pieces of biometric information registered in the authentication information database and the authentication rule is satisfied.

8. The server device according to claim 1, wherein
the at least one processor is configured to execute the instructions to perform:
determining which of the first biometric authentication and the second biometric authentication is to be executed based on a terminal ID included in the first authentication request and the second authentication request.

9. The server device according to claim 4, wherein the biometric information is a face image or a feature amount generated from the face image.

10. (canceled)

11. A biometric authentication method comprising:
in a server device,
acquiring an authentication rule including a condition for determining that authentication is successful; and
performing first biometric authentication in response to a first authentication request transmitted from a first terminal and performing second biometric authentication using the authentication rule in response to a second authentication request transmitted from a second terminal.

12. A non-transitory computer-readable storage medium storing a program for causing a computer mounted on a server device to execute:
a step of acquiring an authentication rule including a condition for determining that authentication is successful; and
a step of performing first biometric authentication in response to a first authentication request transmitted from a first terminal and performing second biometric authentication using the authentication rule in response to a second authentication request transmitted from a second terminal.
